(19) United States
(12) Patent Application Publication
(10) Pub. No.: US 2005/0150912 A1
(43) Pub. Date: Jul. 14, 2005

(54) Multiple-tap adapter for drink dispenser

(76) Inventors: Christopher Casey, Shrewsbury, MA (US); Michael Webster, Shrewsbury, MA (US)

Correspondence Address: Brett N. Dorny, Esq.;LAW OFFICE OF BRETT N. DORNY, 321 Church Street, Northborough, MA, 01532, US

(21) Appl. No.: 11/005,144

(22) Filed: Dec. 6, 2004

Related U.S. Application Data
(60) Provisional application No. 60/535,906, filed on Jan. 12, 2004.

(51) Int. Cl. G01F 11/06

(52) U.S. Cl. 222/330

(57) ABSTRACT

An adapter is used to allow beer to be dispensed from a single keg to a plurality of containers simultaneously. The adapter includes a connector for attaching the adapter to the keg tap spout. It further includes a separator for dividing a fluid flow from the keg into a plurality of flows. A plurality of spigots are connected to the separator for controlling flows into the plurality of containers.

### CROSS REFERENCES

This application claims priority to U.S. Provisional Patent Application Ser. No. 60/535,906, filed Jan. 11, 2004.

### BACKGROUND OF THE INVENTION

1. Field of the Invention

The present invention relates to devices for dispensing of drinks such as beer. More particularly, it relates to a device for dispensing of multiple drinks simultaneously from a single drink dispenser.

2. Discussion of Related Art

Typically, dispensing of beer from a keg requires that the keg be tapped and a line from the keg tap spout be installed to allow the beer, under pressure, to flow to a dispensing mechanism, such as spigot on the top of the bar. Sometimes, the spigot is connected directly to the keg tap spout for dispensing beer at the keg.

Establishments that dispense and sell beer appear to be relegated to a one keg, one pouring spout to fill containers of beer for customers. In most bars there are spigots at the bar with fancy handles that work the spigots to dispense a particular type of beer. The beer is dispensed from a keg that usually resides in the floor below in a cooler in a cooler on the same level as the dispensing levers. Therefore, waiters or waitresses must queue up at the beer dispensing area of the bar and wait for the bartender to pour their order, one by one. Typically, if an other dispensing area is located at the other end of the bar, it is served by a separate set of kegs. The use of multiple kegs for the same type of beer requires additional cooler space and additional costs for electricity to cool the kegs. Additionally, with multiple kegs, the beer in each keg is used more slowly and may not remain fresh.

In some instances, such as at parties with a fixed bar, the keg tap spout is used to dispense the beer at the keg. However, only one container can be filled at a time. For large parties, guest may have to wait in line for an opportunity to receive beer.

Several devices are available for dispensing beer from a keg to multiple locations. For example, U.S. Pat. No. 5,332,132 discloses a tap structure with an exit tube having an increased diameter and a plurality of spouts from the tap. With this device, several containers can be filled simultaneously. U.S. Pat. No. 6,796,465 discloses a keg coupler with a multiple output fitting. This device also allows multiple spigots to be attached to a single keg. However, with these devices, the tap structure must be modified. Either the entire tap must be replaced or the coupler must be replaced. It is impossible to use kegs with conventional taps.

### SUMMARY OF THE INVENTION

The present invention includes an adapter attachable to a conventional keg spout which allows dispensing of the keg contents to multiple containers simultaneously. According to an aspect of the invention, the adapter includes a connector which fits over the keg tap spout. The connector is formed to connect to the keg tap spout with sufficient force to maintain the pressure in the keg and in the dispensing lines. According to another aspect of the invention, the connector is connected to a multiple line separator. The separator divides a single input into a plurality of outputs. Each of the outputs is connected to a spigot for dispensing beer or other drink from the keg.

### BRIEF DESCRIPTION OF THE DRAWINGS

FIG. 1 is a view of a multiple tap dispensing adapter according to an embodiment of the present invention.

FIG. 2 is a cross sectional view of a connector according to an embodiment of the present invention.

FIG. 3 is a cross sectional view of a separator according to an embodiment of the present invention.

### DETAILED DESCRIPTION

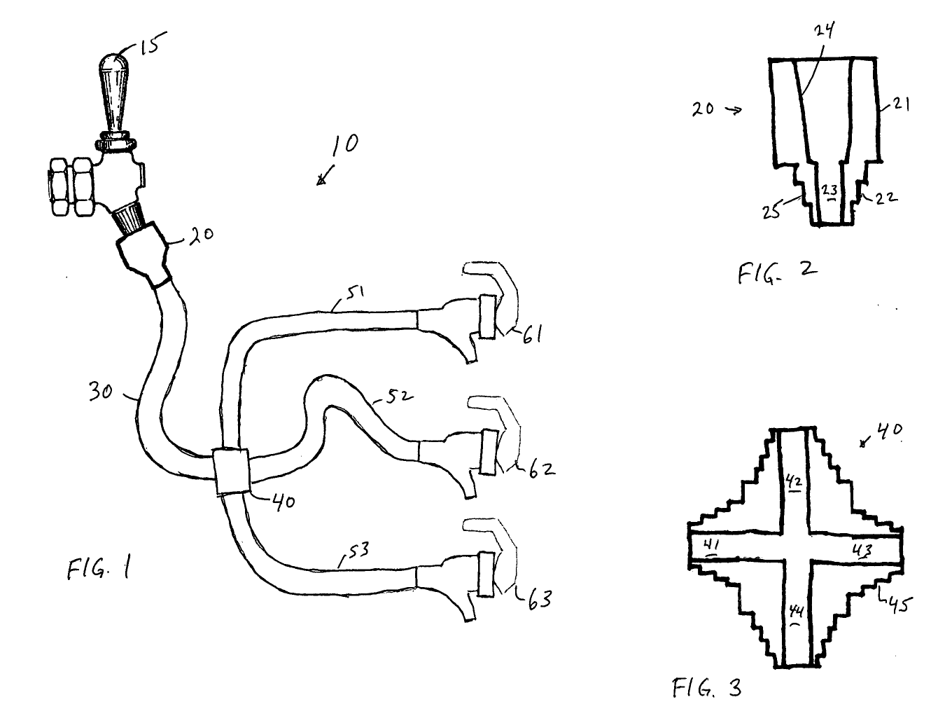

A multiple tap dispensing adapter allows more than one container to be filled from a single keg tap spout. The adapter is removably attached to the keg tap spout and provides fluid flow passages to multiple spigots. As illustrated in FIG. 1, according to an embodiment of the invention, a multiple tap dispensing adapter 10 includes a connector 20 for connecting to a keg tap spout 15. The keg is not illustrated, but is connected to the keg tap spout 15 in any known manner. A connector hose 30 provides a flow passage from the connector 20 to a separator 40. The separator 40 creates a plurality of output flow channels. Each of the output flow channels is connected to a dispensing hose 51, 52, 53. Each dispensing hose 51, 52, 53 is connected to a spigot 61, 62, 63.

FIG. 2 is cross sectional view of an embodiment of a connector 20. The connector 20 includes a spout attachment part 21 and a hose attachment part 22. The connector 20 is substantially cylindrical in shape with a cylindrical flow passage 23 through the center. The spout attachment part 21 has an inner diameter 24 substantially the same as the outer diameter of the keg tap spout 15. As illustrated in FIG. 2, the inner diameter 24 may be angled so that it is smaller towards the hose attachment part 22. The connector 20 is positioned on the keg tap spout and fits to provide a tight seal so that pressure is maintained within the keg and the contents do not leak out. The hose attachment part 22 may include a stepped outer diameter 25 for receiving the connector hose 30. The stepped diameter 25 allows a tight seal with hoses of various diameters. The connector hose 30 may be connected to the hose attachment part 22 by friction or a clamp may be used to hold the hose in place. The hose 30 must be connected with sufficient force to maintain the pressure in the keg and to prevent leakage of contents. Other mechanisms and structures could be used to attach the connector hose 30 to the connector 20.

FIG. 3 is a cross sectional view of a separator 40 according to an embodiment of the present invention. The separator 40 in FIG. 3 includes a single input flow passage 41 and three output flow passages 42, 43, 44. The flow passages 41, 42, 43, 44 are arranged to form an X in a single plane. However, the number and arrangement of the flow passages may be varied to accommodate any number of dispensers. Furthermore, FIG. 3 illustrates all of the flow passages as having substantially the same diameter. The flow passages may have different diameters in order to maintain proper pressurization within the adapter. Each of the flow passages includes a stepped outer diameter 45 for connecting to respective hoses. As with the connector 20, various mechanisms can be used for attaching the hoses to the separator 40. FIG. 1 illustrates a single separator 40 for the adapter 10. However, multiple separators 40 could be used at different locations to provide additional dispensing lines. Appropriate hoses would be used to connect the separators 40 to achieve a desired configuration. Furthermore, the separator 40 and connector 20 could be formed as a single unit without the connector hose.

When the adapter 10 is connected to the keg tap spout 15, the spout is turned on to allow fluid flow into the adapter 10. The fluid flows to each of the spigots 61, 62, 63. Operation of any one or all of the spigots 61, 62, 63 allows the fluid to flow out of the adapter 10 and into a container (not shown). The spigots 61, 62, 63 may be attached to a bar in a conventional manner or may hang loose depending upon the intended use. A single keg can be connected to multiple dispensing areas in a bar. Additionally, multiple guests can fill containers from a keg simultaneously.

The components of the adapter 10 are dimensioned to accommodate pressure drops during dispensing operations. The pressure in the keg must be maintained in order to provide flow. The flow at any of the spigots 61, 62, 63 should not depend upon the distance from the keg. Additional pressurization may be added at various locations in the adapter 10 in order to achieve adequate flow at the spigots 61, 62, 63.

A variety of materials can be used for the components of the adapter 10. Such components would include stainless steel, plastic, rubber, resins, etc. The specific material used depends upon the nature of the use. Factors to consider in selecting a material include the ease of installation, the installation design, the pressure levels, ease of maintenance, ease of cleaning, and sanitation or food use requirements. The material should be safe for storage and dispensing of consumable items.

The present invention has been described in connection with dispensing beer from a keg. However, it may be used for dispensing of other liquids or materials from a spout. The adapter 10 of the present invention may be connected to any type of spout to provide multiple dispensing spigots from a single spout. Thus, it may be used for drinks other than beer. It may also be used for dispensing fluids from other containers besides kegs.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A multiple tap adapter for dispensing a fluid from a first container having a spout to a plurality of second containers, the adapter comprising:
a connector for releasably connecting to the spout;
a separator, the separator having an input to the connector for fluid flow and a plurality of outputs for fluid flow to the input; and
a plurality of spigots for selectively dispensing a fluid into one of the plurality of second containers, each spigot being attached to one of the plurality of outputs of the separator.

2. The multiple tap adapter according to claim 1, wherein the first container is a beer keg and the fluid is beer.

3. The multiple tap adapter according to claim 1, wherein the plurality of outputs includes three outputs.

4. The multiple tap adapter according to claim 1, further comprising a connector hose for connecting the connector to the input of the separator.

5. The multiple tap adapter according to claim 1, further comprising at least one hose for connecting one of the plurality of outputs to one of the plurality of spigots.

6. The multiple tap adapter according to claim 1, further comprising a plurality of hoses, each hose connecting one of the plurality of outputs to a corresponding one of the plurality of spigots.

7. The multiple tap adapter according to claim 1, wherein the outputs and plurality of hoses are dimensioned such that pressure of the fluid at each spigot is approximately equal.
